(19) United States
(12) Patent Application Publication
(10) Pub. No.: US 2014/0326654 A1
(43) Pub. Date: Nov. 6, 2014

(54) DEVICE FOR FILTERING WATER

(71) Applicants: Roberto MARCHETTI, Modena (IT); Eldad MAZIEL, Mazkeret Batya (IL)

(72) Inventor: Eldad Maziel, Mazkeret Batya (IL)

(21) Appl. No.: 14/358,647

(22) PCT Filed: Nov. 15, 2012
(86) PCT No.: PCT/IB2012/002367

§ 371 Date: May 15, 2014

(30) Foreign Application Priority Data
Nov. 15, 2011 (IT) MO2011A000290

(51) Int. Cl. B01D 24/00; B01D 29/56; B01D 24/10; B01D 29/05

(52) U.S. Cl. CPC B01D 24/007; B01D 29/05; B01D 29/56; B01D 24/10
USPC 210/289; 210/435; 210/450; 210/335; 210/336

(57) ABSTRACT

The device for filtering water, includes a containment body inside which is placed at least a filter element and includes at least a prefiltration chamber, provided with at least an inlet for the water to be filtered, and at least a postfiltration chamber, provided with at least an outlet for the filtered water, the prefiltration chamber and the postfiltration chamber being in communication with the filter element, where the filter element is substantially sheet shaped and defines an open edge.

### TECHNICAL FIELD

The present invention relates to a device for filtering water.

### BACKGROUND ART

The machine for water treatment as, for example, soda carbonator or the like, comprises generally a filtering device suitable to remove water impurities.

The filtering devices of known type comprise a filter element, generally made of active carbon, that presents a couple of filtering surfaces one of which is intercepted by water to be filtered and the other one is crossed by the filtered water.

It is known that the water filtration causes an high pressure difference between the extremities of the filter element used and, therefore, a force acting on the filter element itself which intensity is proportional to both the pressure difference and the relative area intercepted by the water.

For this reason, in water filtration are not generally used flat filter elements, i.e. those filters whose filtering surfaces are substantially plane and that are of common use in air filtration. Indeed, in this case, the force due to pressure difference would bend the filter element up to cause its rupture or the malfunctioning.

The filter elements mainly used in water filtration are of the cylindrical type. This kind of filters is substantially tubular shaped, where the outer area is intercepted by the water to be filtered and the inner area collects the filtered water.

This particular shape allows the filter element to better withstand the action of the force due to the pressure difference, being that this force is divided into many components that are distributed on overall its outer surface, substantially balancing each other.

More in details, the dimension of mesh of the filter element decreases by going from outside towards inside, and for this reason the outer portions are adapted to retain the bigger particles while the inner portions are adapted to retain the smaller particles.

This kind of device presents some drawbacks.

In particular, the cylindrical filter elements doesn't allow to obtain an efficient filtering action of the smaller particles contained in the water to be filtered.

Indeed, the water crossing the filter element increases progressively its speed going from outside towards inside due to the reduction of volume occupied by the various portions of the filter element itself.

This progressive increasing of water speed involves that the time during which the water remains in contact with the various portions of the filter element (defined “contact time”) decreases progressively little by little that water goes towards inside. As a consequence, therefore, the inner portions of the filter element, suitable to retain the smaller particles contained in the water to be filtered, are those with the lower contact time.

Since it is known that the filtration efficiency is as good as higher is the contact time, it follows that the cylindrical filter elements doesn't allow to obtain an efficient water filtration, in particular of the smaller particles.

Another drawbacks of the filtering devices of known type consists in the fact that they are of complex inserting/extraction from the relative machine for the water treatment.

### DISCLOSURE OF THE INVENTION

The main aim of the present invention is to provide a device for filtering water that allows to obtain an efficient removal of both the bigger and the smaller particles contained in the water to be filtered.

Within this aim an object of the present invention is to obtain a more efficient filtration, with respect to the cylindrical filtering devices, of the smaller particles contained in the water to be treated.

Another object of the present invention is to provide a filtering device that allows to increase, with respect to the device of known type, the contact time of water with the filter element.

Yet another object of the present invention is to provide a water filtering device that could be easily inserted and removed from the relative machine for the treatment of water.

Another object of this invention is to provide a device for filtering water that allows to overcome the mentioned drawbacks of the background art, in the ambit of a simple, rational, easy, effective to use and low cost solution.

The above objects are achieved by this device for filtering water, comprising:
a containment body inside which is placed at least a filter element and comprising at least a prefiltration chamber provided with at least an inlet for the water to be filtered and at least a postfiltration chamber provided with at least an outlet for the filtered water, said prefiltration chamber and said postfiltration chamber being in communication with said filter element;
   characterized in that said filter element is substantially sheet shaped and defines an open edge.

### BRIEF DESCRIPTION OF THE DRAWINGS

Other characteristics and advantages of the present invention will become more evident from the description of a preferred, but not sole, embodiment of a device for filtering water, illustrated purely as an example but not limited to the annexed drawings in which:

FIG. 1 is an axonometric view of a device according to the invention in in a first form of embodiment;

FIG. 2 is first section view of the filtering device of FIG. 1;

FIG. 3 is a second section and exploded view of a portion of the filtering device of FIG. 1;

FIG. 4 is a first section view of a filtering device according to the invention, in a second form of embodiment;

FIG. 5 is a second section view of the filtering device of FIG. 4;

FIG. 6 is a first section view of a filtering device according to the invention, in a third form of embodiment;

FIG. 7 is a second section view of the device of FIG. 6;

FIG. 8 is an axonometric view, partially broken, of a filtering device according to the invention, in a third form of embodiment;

FIG. 9 is a first section view of the device of FIG. 8;

FIG. 10 is a second section view of the device of FIG. 8;

FIG. 11 is a section view of a portion of a water treatment machine with the containment structure of the filtering device in the insertion/removal position;

FIG. 12 is a section of the portion of FIG. 11 with the containment structure in the working position;

FIG. 13 is a section view of the filtering device of FIG. 12 in the third form of embodiment.

### WAYS OF CARRYING OUT THE INVENTION

With particular reference to such figures, globally indicated by reference number 1 a device for filtering water.

The device 1 comprises a containment body 2 inside which is placed at least a filter element 6 suitable to retain impurities contained into the water to be filtered. In the present treatise water is referred to as the used liquid, even if it cannot be excluded that the device according to the present invention could be used also with liquids of different typology.

The contaimnent body 2 is internally hollow and defines at least a prefiltration chamber 3a provided with at least one inlet 4 for the inflow of the water to be filtered and at least a postfiltration chamber 3b provided with at least one outlet 5 for the outflow of filtered water. The prefiltration chamber 3a and the postfiltration chamber 3b are both in communication with the filter element 6.

By considering the sense of circulation of the water inside the body 2, the filter element 6 is interposed between the inlet 4 and the outlet 5 and, more in particular, between the prefiltration chamber 3a and the postfiltration chamber 3b.

According to the invention, the filter element 6 is substantially sheet-shaped and defines an open edge.

With the term “sheet-shaped” used in the present description it has to be intended an element having two dimensions (length and width) that are predominant with respect to the third dimension (thickness).

The filter element 6 therefore presents two faces opposite to each other, identified in the figures from 8 to 10 with the reference numbers 6a and 6b, and a thickness identified with the reference 17. The filtering faces 6a and 6b are substantially flat, even if different form of embodiments in which they are pleated are not ruled out.

The exact geometry of the faces 6a and 6b is closely related to the type of the material which constitutes the filter element 6.

The filter element 6 is, for example, made of a block of active carbon. Alternative embodiments of the filter element 6 cannot however be ruled out.

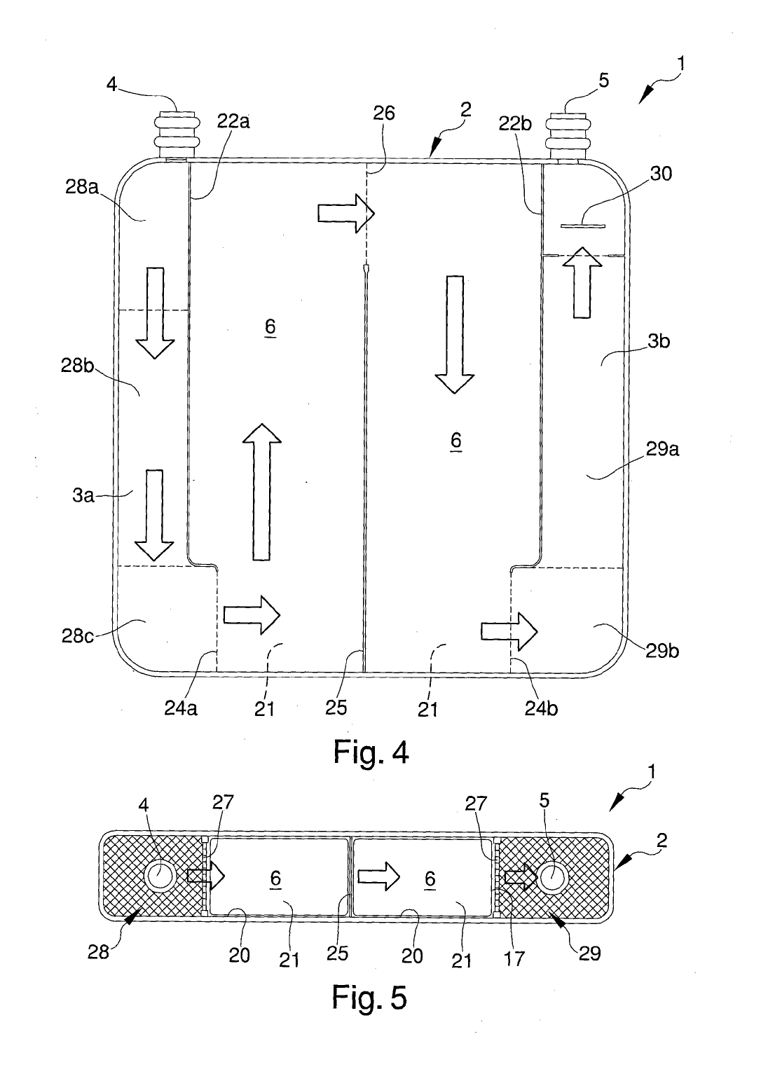

For example, in the second form of embodiment showed in the FIGS. 4 and 5, the filter element 6 comprises a filtering material of the granular or foam type.

More in detail, the filter element 6 comprises at least an envelope 20, for example made of nylon, which contains a filtering material 21 of the granular or foam type, for example granular active carbon. The filtering material 21 of the granular or foam type allows to obtain a wide exchange surface with water, allowing an efficient filtration in particular of the chlorine contained in the water. Suitably, the envelope 20 is net-shaped, for example with meshes of approximately 1 μm.

In a further form of embodiment, the filter element 6 can be constituted by a non woven tissue, for example made of polyester of the pleated type, associated with a foam material made of polyether.

The body 2 comprises a top wall 2a and a bottom wall 2b faced, respectively, to the faces 6a and 6b of the filter element 6.

As it is visible by the figures, each one of the prefiltration and postfiltration chamber 3a and 3b comprises at least a relative portion placed at least in part laterally to the filter element 6.

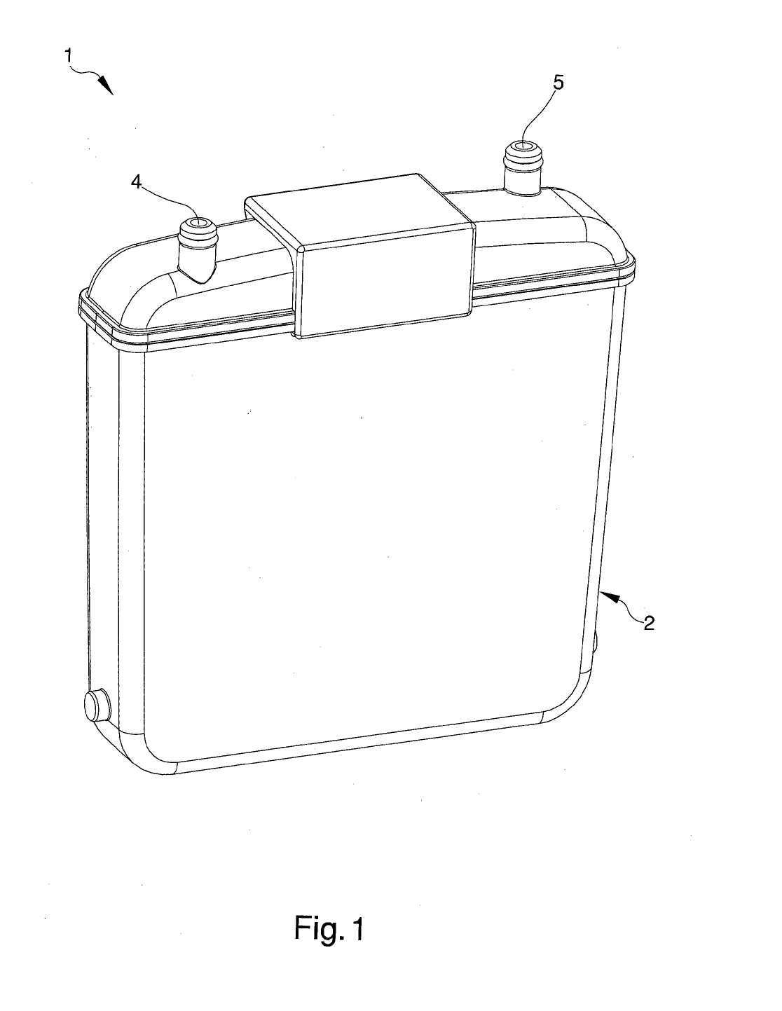

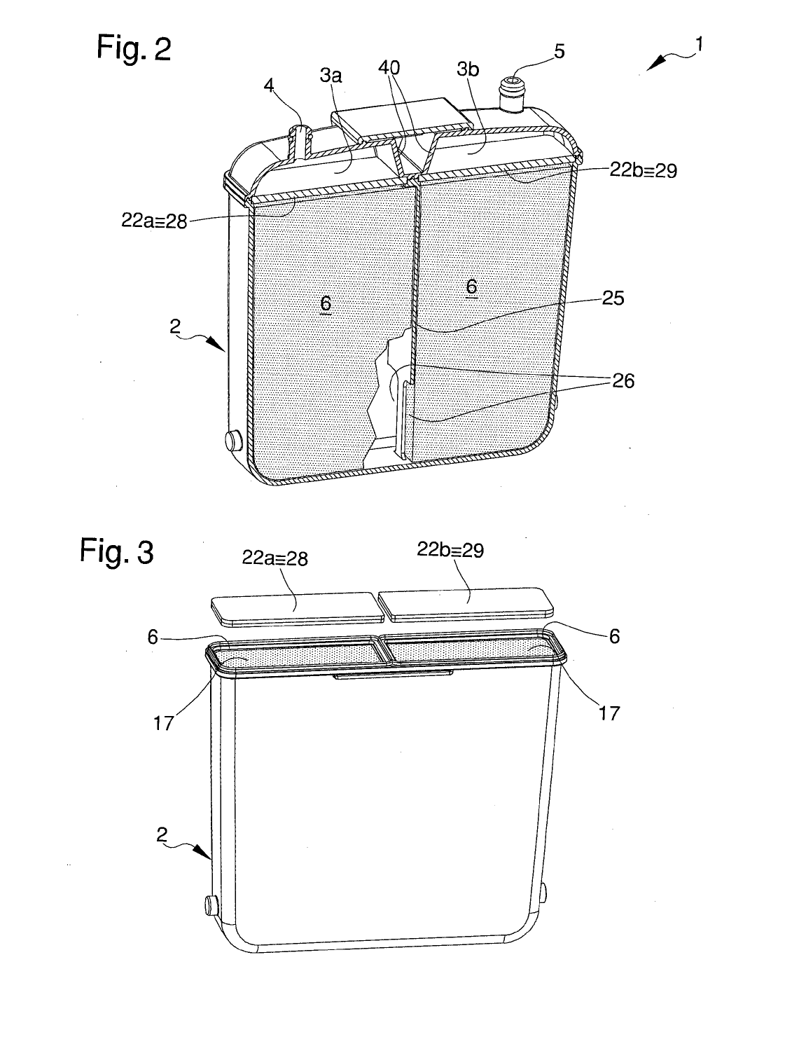

In the embodiment showed in the FIGS. 1, 2 and 3, the prefiltration chamber 3a and the postfiltration chamber 3b are placed on the same side with respect to the filter element 6. More in particular, in this first embodiment, the prefiltration chamber 3a and the postfiltration chamber 3b are placed side by side. The prefiltration chamber 3a and the posfiltration chamber 3b are separated by at least a partition wall 40.

In the other embodiments showed in the figures, instead, the prefiltration chamber 3a and the postfiltration chamber 3b are placed at opposite sides with respect to the filter element 6.

In the embodiments showed in the figures from 1 to 7, the opposite faces 6a and 6b of the filter element 6 cooperate with the top wall 6a and the bottom wall 6b of the body 2 in such a way to force the water to pass through the thickness 17 of the filter element 6.

More in detail, in the first and in the second embodiment showed in the figure from 1 to 3 and 4, 5 respectively, the top wall 2a and the bottom wall 2b are placed at the faces 6a and 6b respectively in order to force the water to pass through the thickness of the filter element itself. Preferably, the walls 2a and 2b are placed substantially (for less than eventual defects of flatness) placed resting on the faces 6a and 6b. In this embodiments, the prefiltration chamber 3a and the postfiltration chamber 3b are faced to the thickness 17.

Advantageously, in the first and second embodiment the body 2 comprises at least a containment wall 22a,22b interposed between the filter element 6 and at least one of the prefiltration chamber 3a and the postfiltration chamber 3b. The containment wall 22a,22b is faced to the thickness 17 of the filter element 6. At least one between the prefiltration chamber 3a and the postfiltration chamber 3b communicates with the thickness 17 of the filter element 6 by means of the relative containment wall 22a,22b and is substantially aligned with the filter element itself in correspondence of its thickness 17.

Preferably, the body 2 comprises at least two containment walls, of which at least a first containment wall 22a, interposed between the filter element 6 and the prefiltration chamber 3a, and a second containment wall 22b, interposed between the filter element 6 and the postfiltration chamber 3b. Such containment walls 22a, 22b extend from the top wall 2a to the bottom wall 2b so crossing entirely the internal volume of the body 2 at least along a first direction.

Therefore, the containment walls 22a and 22b delimit at least in part the prefiltration chamber 3a and the postfiltration chamber 3b, separating them from the filter element 6.

As easy to understand for person skilled in the art, the first and second containment walls 22a and 22b can be separated from one another or formed monolithically.

In the first embodiment showed in the figures from 1 to 3, at least one of the containment walls 22a, 22b comprises prefiltration means 28 and/or postfiltration means 29 (depending on which chamber 3a, 3b is separated from the filter element 6 by the containment wall) adapted to allow the wpassage of water.

Preferably, the first containment wall 22a comprises prefiltration means 28 suitable to remove the solid particles and the residues eventually present in the water to be filtered and the second containment wall 22b comprises postfiltration means 29 suitable to remove residues eventually remained in the filtered water.

More in detail, the prefiltration means 28 and/or the postfiltration means 29 comprise, for example, portions of non-woven tissue (non woven melt blow) eventually covered with a net made of nylon.

The pre and postfiltration chambers 3a and 3b are so communicating with the filter element 6 by means of the prefiltration means 28 and of the postfiltration means 29 respectively.

In this first embodiment, the inlet 4 and the outlet 5 are preferably placed along the lateral projection of the filter element 6, in such a way to reduce consequently the overall dimensions of the device 1.

In the second embodiment showed in the FIGS. 4 and 5, at least one of the containment walls 22a, 22b extends inside the body 2 in such a way to define at least a passageway 24a,24b of the water entering/exiting the filter element 6 and facing to the thickness 17 of the filter element itself.

Preferably, the first containment wall 22a defines at least a first passageway 24a and the second containment wall defines at least a second passageway 24b.

In this second embodiment, the containment walls 22a and 22b entirely cross the interior of the body 2 along a first direction, i.e. from the top wall 2a to the bottom wall 2b, and partially along a second direction transversal to the first direction. The first and the second containment wall 22a and 22b are, in this case, of the solid type, i.e. they cannot be crossed by water, the latter being obliged to flow through the relative passageways 24a, 24b.

Advantageously, in this second embodiment, the prefiltration chamber 3a and/or the postfiltration chamber 3b comprise, respectively, the prefiltration means 28 for removing the solid particles and the residues. eventually present in the water to be filtered and the postfiltration means 29 for removing the residues of active carbon eventually remained in the filtered water.

More in detail, the prefiltration means 28 comprise, for example, some portions of non woven tissue (non woven melt blow) having thinness gradually increasing going from the inlet 4 towards the filter element 6. In the particular form of embodiment showed in the FIGS. 4 and 5, the prefiltration means 28 comprise three portions of non woven tissue of the melt blow type and made of polypropylene, respectively 28a, 28b, 28c, arranged in sequence to each other and whose dimensions are, respectively of about 50 μm, 15 μm and 5 μm.

Alternative embodiments cannot however be ruled out wherein the prefiltration means 28 are made, for example, with materials and/or with dimensions different from those cited above.

The postfiltration means 29 comprise at least one portion of non woven tissue 29a, for example made of plypropylene, and having thinness comprised between 1 μm and 5 μm. In the form of embodiment showed in the FIGS. 4 and 5, the postfiltration means 29 also comprise a postfiltration element 29b of the granular type, for example made of Polyphosphate, adapted to remove the scale (Calcium Carbonate) from the water. Suitably, the postfiltration element 29b is placed upwardly of the non woven tissue 29a in the sense of water flow towards the outlet 5.

Alternative embodiments cannot however be ruled out wherein the prefiltration means 28 and/or the postfiltration means 29 comprise an open cells foam or the. like.

In the second embodiment, in which the chambers 3a and 3b are placed at opposite sides of the filter element 6, the passageways 24a and 24b are placed transversal with respect to the inlet 4 and the outlet 5 respectively.

Alternative “hybrid” embodiments cannot however be ruled out, i.e. which involve the combination of the teachings of the first and second embodiments disclosed above. For example, it is possible to find embodiments in which one of the containment wall 22a, 22b presents relative pre-postfiltration means 28, 29 and the other one presents a relative water passageway 24a, 24b. Moreover, it is also possible to find embodiments comprising only one containment wall 22a,22b.

Everything that has been disclosed till now can be feasible independently by the number of filter element 6 contained into the body 2.

Advantageously, both in the first and in the second embodiments the device 1 comprises two separated filter elements 6, arranged adjacent to each other and suitable to be intercepted in succession by the water during the passage from the inlet 4 to the outlet 5. The filter elements 6 are therefore placed in series with respect to the water direction inside the body 2.

The prefiltration chamber 3a is therefore in communication with a filter element 6, while the postfiltration chamber 3b is in communication with the other filter element 6.

Preferably, both in the first and in the second embodiment, the device 1 comprises at least a separation wall 25 placed between the filter elements 6, where the separation wall itself and the containment walls 22a and 22b are disposed in such a way to define a labyrinthine path for the water, so as to increase the contact time of the water with the filter elements 6. More in detail, the separation wall 25 defines a further passageway 26 of the water exiting from the first filter element and entering into the second filter element.

Such further passageway 26 is placed distal from the pre and postfiltration means 28, 29 in the first embodiment disclosed, while it is placed distal from the passageways 24a and 24b in the second embodiment disclosed.

Also the separation wall 25 is of the rigid type, for example made of plastic or the like and extends itself, except that at the further passageway 26, from the top wall 2a to the bottom wall 2b. The containment walls 22a, 22b and the separation wall 25 are disposed substantially perpendicular to each other in the first embodiment and parallel to each other in the second embodiment.

In particular, in the first embodiment the separation wall 25 extends from the region interposed between the first and the second containment wall 22a and 22b.

Preferably, in correspondence of at least one of the water passageways 24a, 24b and 26 is placed a filtering net 27 provided with meshes whose dimensions are comprised, for example, between 50 μm and 100 μm.

In the second embodiment, as visible in FIG. 4, along the postfiltration chamber 3b, in correspondence of the outlet 5, is placed an interrupting element 30 of the water flow.

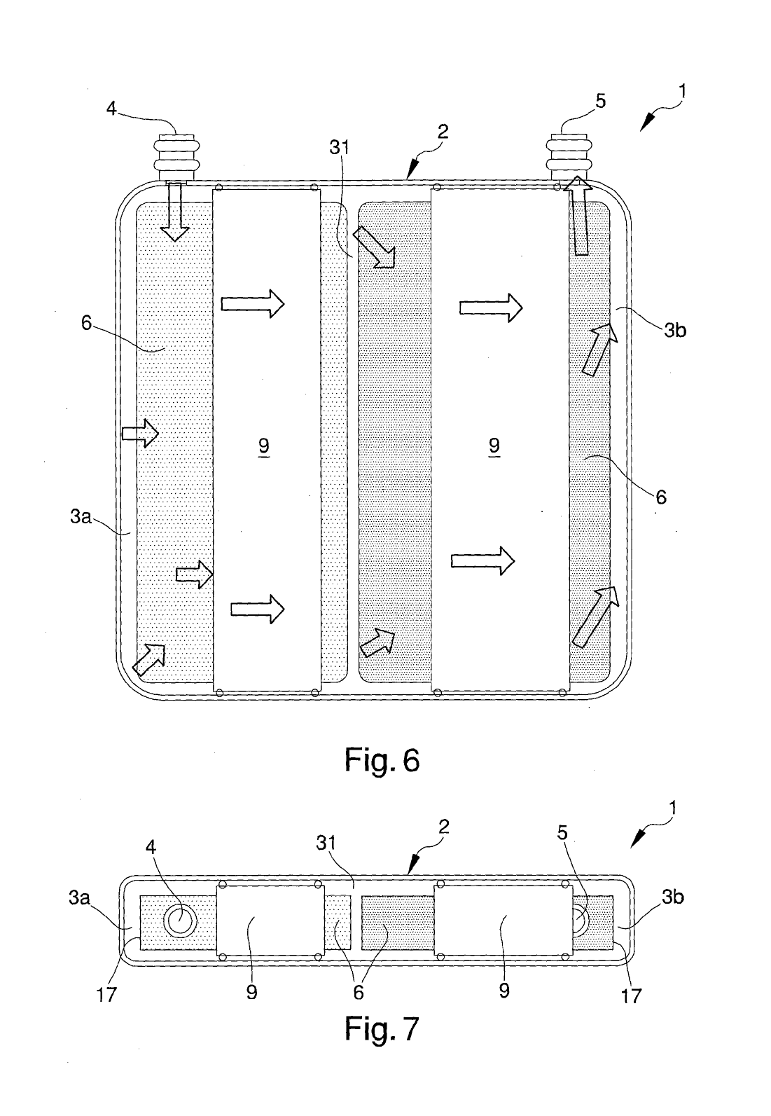

In the third embodiment, showed in the FIGS. 6 and 7, the faces 6a and 6b of the filter element 6 cooperate with the body 2 by means of at least a sealing element 9 in order to force the passage of the water through the thickness 17 of the filter element itself.

The sealing element 9 is interposed between the filter element 6 and the body 2 in such a way to separate the prefiltration chamber 3a from the postfiltration chamber 3b. More in particular, the sealing element 9 is interposed between the filter element 6 and the top and bottom walls 2a and 2b of the body 2 so as to force the water flow through the filter element itself in a direction substantially parallel to the faces 6a and 6b. In other words, in correspondence of the sealing element 9, the water is pushed to pass through the thickness 17 of the filter element 6.

In this embodiment, the filter element 6 is constituted, for example, by a block of active carbon or the like.

Also in this third embodiment, into the body 2 are placed two filter elements 6 arranged adjacent and spaced to each other, on each one of them is placed at least a respective sealing element 9. The two filter elements 6 have different porosity degree with respect to each other, more in particular, the filter element 6 firstly intercepted by the water flow is suitable to exploit a coarser filtration with respect to the other filter element which is intercepted last.

By placing several filter elements 6, with the relative sealing elements 9, in succession to each other it is so possible to increase the contact time of the water with the filter elements themselves and, in this way, increase the filtration efficiency.

The two sealing elements 9 delimit the prefiltration chamber 3a and the postfiltration chamber 3b and define, moreover, an intermediate chamber 31 interposed between them. As it is easy to understood, the water flow through the chambers 3a, 3b and 31 is of the circumferential type, while at the sealing elements 9 the water flow through the relative filter element 6 is substantially linear.

In this third embodiment, the sealing elements 9 also have the function of supporting the respective filter elements 6 and are suitable to compensate the force acting on the filter elements themselves that is due to the pressure difference at their opposite ends. Such a force, in particular, is directed parallel to the faces 6a and 6b.

In the fourth embodiment, represented in the figures from 8 to 10, the water flow into the filtration chamber 3 is substantially perpendicular to the faces 6a and 6b of the filter element 6.

In this fourth embodiment, therefore, the force acting on the filter element 6 and due to the pressure difference that, in use, occurs at its ends is of high intensity because acts on the widest surfaces of the filter element itself.

Suitably, the body 2 comprises at least one support element 7 of the filter element 6 that cooperates with one of the faces 6a and 6b in order to compensate the force acting on them.

Advantageously, the support element 7 is placed inside the postfiltration chamber 3b and cooperates with the second face 6b. More particularly, the second face 6b leans on the support element 7 which, therefore, is adapted to sustain the filter element 6 during the functioning, in order to avoid the inflection of its central portion.

Preferably, the support element 7 is defined in a single piece with the body 2.

As above mentioned, even in this fourth form of embodiment the device 1 comprise a sealing element 19 associated to the filter element 6 and adapted to separate the prefiltration chamber 3a from the postfiltration chamber 3b.

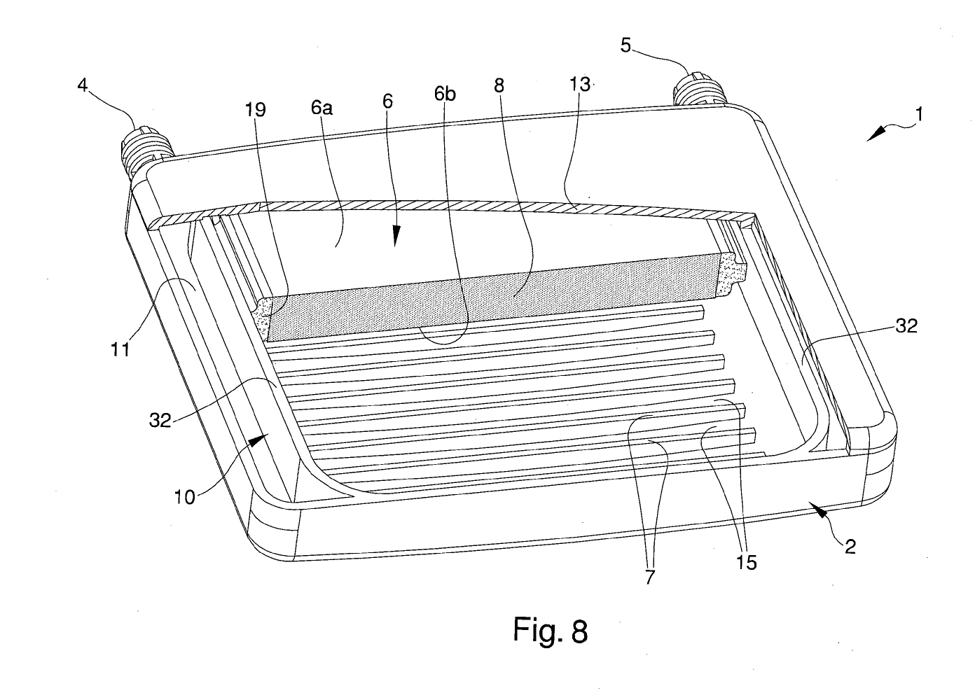

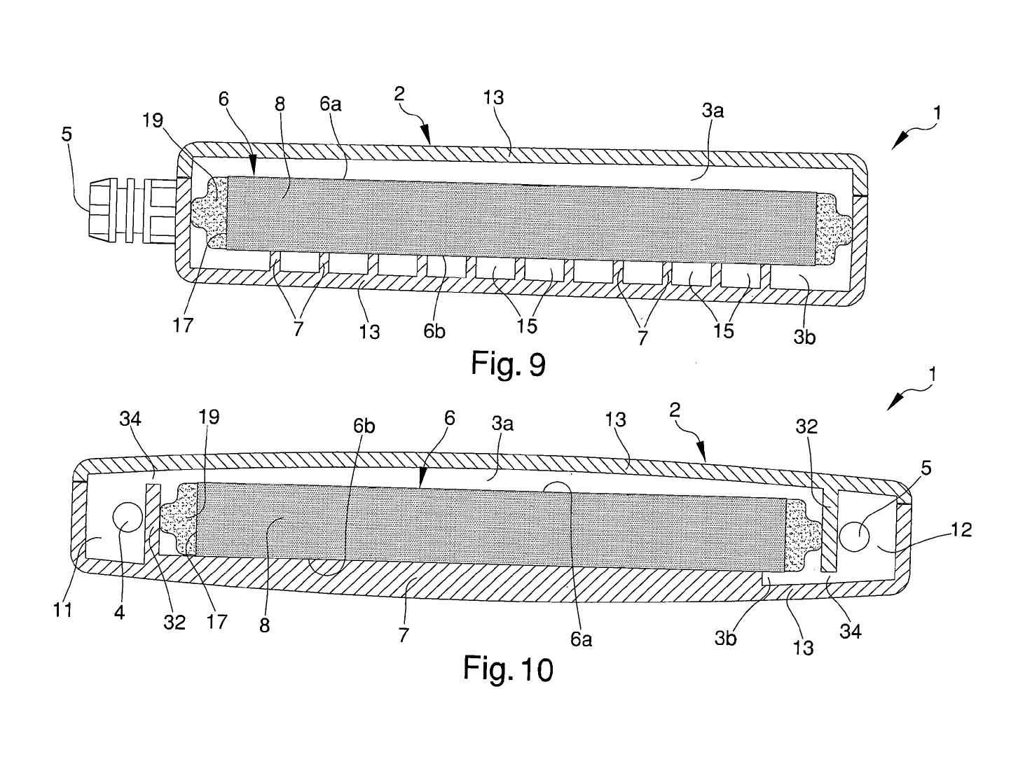

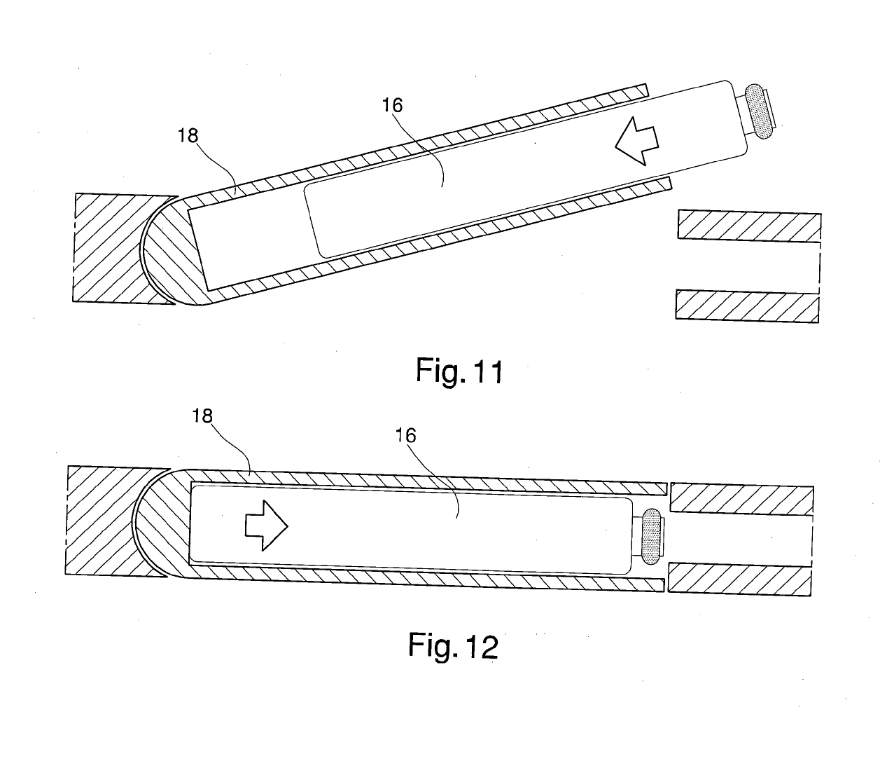

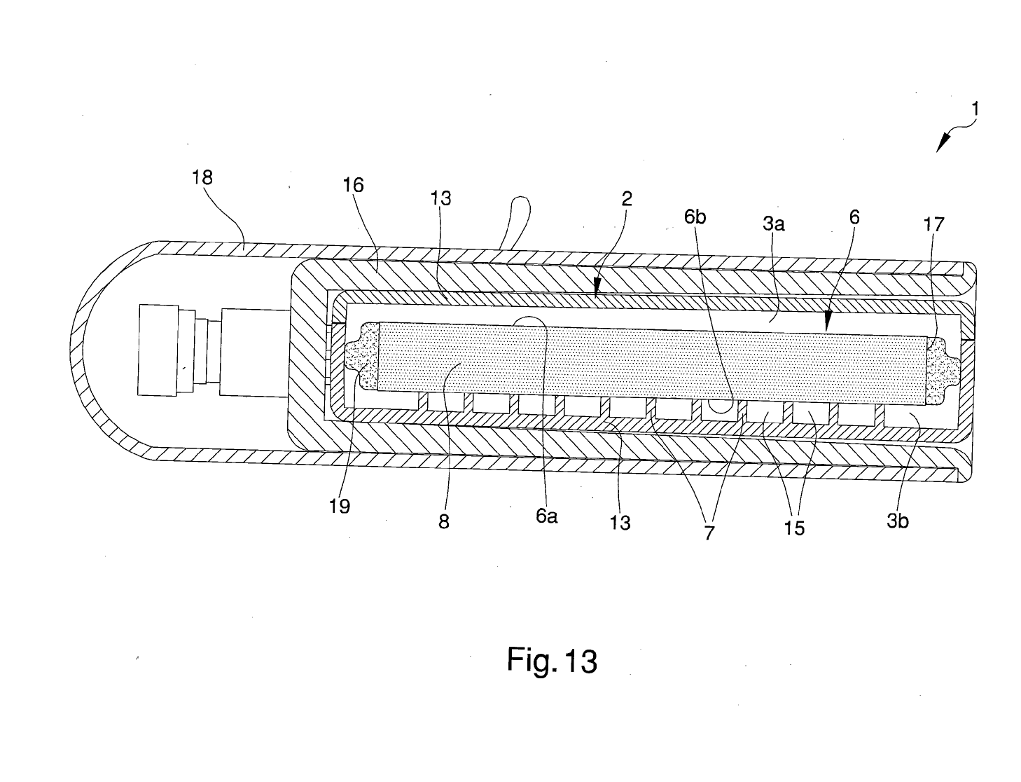

More in particular, as can be seen from the FIGS. 8, 9 and 10, the sealing element 19 is placed along the perimeter of the filter element 6 in correspondence of its thickness 17.

Preferably, the filter element 6 is of the type of a carbon block or the like and the sealing element 9 is made of rubber.

In some cases, the filter element 6 comprises also one or more prefiltering and/or postfiltering layers placed, respectively, on the first and on the second face 6a and 6b. The prefiltering and postfiltering layers are generally used for increasing the overall contact time of the water with the filter element 6, in order to obtain a more efficient filtration.

More in detail, the prefiltration chamber 3a is delimited at least in part by the first face 6a and communicates with the inlet 4 while the postfiltration chamber 3b is delimitated at least in part by the second face 6b and communicates with the outlet 5.

Preferably, the body 2 comprises at least a containment element 10 placed inside the body 2 itself and defining a closed edge inside which the filter element 6 is placed watertight. Suitably, the containment element 10 is made integral with the body 2.

The containment element 10 comprises at least two walls 32, placed at opposite sides of the filter element 6, that extend themselves respectively inside the prefiltration chamber 3a and the postfiltration chamber 3b so as to define respective water passageways 34. More in particular, the containment walls 32 extend themselves from the top wall 2a and from the bottom wall 2b towards the interior of the body 2 respectively. Each one of the walls 32 therefore presents an end associated to the top wall 2a or to the bottom wall 2b and the other end that is spaced from the bottom wall 2b or from the top wall 2a respectively.

More in detail, the walls 32 delimit, respectively, one inlet conduit 11 communicating with the inlet 4 and, by means of the relative passageway 34, with the first face 6a and one outlet conduit 12 communicating with the outlet 5 and, by means of the relative passageway 34, with the second face 6b.

Advantageously, the body 2 comprises a plurality of support elements 7 spaced to each other.

Preferably, the support elements 7 are placed between the walls 32 and extend transversally with respect to them.

More in detail, each support element 7 presents one end that is associated to the same wall 32, the one that delimits the inlet conduit 11, and the other end that is spaced from the opposite wall 32, the one that delimits the outlet conduit 12.

Each couple of support elements 7 placed side by side defines a relative passage conduit 15 adapted to transport the filtered water that flows through the second filtering face 6b towards the outlet conduit 12.

As visible by FIG. 8, the passage conduit 15 are transversal with respect to the inlet and outlet conduits 11 and 12.

In an alternative embodiment to the fourth solution described here above, the body 2 is shaped in such a way that the inlet 4 directly communicates with the first face 6a. In this alternative embodiment, therefore, only one of the walls 32 defines a relative water passageway 34, while the other wall 32 extends itself entirely between the top and the bottom walls 2a and 2b of the body 2.

Suitably, the device 1 also comprises a box-body 16 that envelope externally the containment body 2.

The box-body 16 is provided with respective apertures placed in correspondence of the inlet and outlet 4 and 5.

In the embodiment represented in the FIGS. 11. 12 and 13, the box-body 16 is inserted into a containment structure 18 rotatably associated to the relative water treatment machine between a working position and an insertion/removal position. More in detail, in the insertion/removal position, the containment structure 18 is accessible from the outside for inserting/extracting the box-body 16. The box-body 16 is movable inside the containment structure 18, with the latter in the working position, between a first configuration in which allows the rotation of the containment structure itself and a second configuration in which is moved with respect to the first configuration for cooperating with the body of the water treatment machine for preventing the movement of the containment structure 18.

It has in practice been ascertained how the described invention achieves the proposed objects and in particular the fact is underlined that it allows to obtain a more efficient filtration with respect to the cylindrical filtering device.

In particular, the filtering device according to the present invention allows to reach a more effective filtration with respect to the device of known type because it allows to increase the contact time of the liquid to be filtered with the relative filter element. This is particularly accentuated in the embodiments which are meant to enable the passage of the liquid through the thickness of the filter element.

More in particular, the use of a filter element sheet shaped allows to obtain a contact time substantially constant in any portion of the filter element itself.

Moreover, the shape of the filter element allows to vary at will the length of the contact time.

In the meantime, the particular structure of the present device allows it to resist to the mechanical stresses due to the difference of pressure at its ends.

Not least, the filtering device according to the present invention it is easily insertable and removable from the relative water treatment machine, so allowing its quick replacement.

1-33. (canceled)

34. A device for filtering water, comprising:
a containment body inside which is placed at least a filter element and comprising at least a prefiltration chamber, provided with at least an inlet for the water to be filtered, and at least a posffiltration chamber, provided with at least an outlet for the filtered water, said prefiltration chamber and said postfiltration chamber being in communication with said filter element;
wherein said filter element is substantially sheet shaped and defines an open edge,

35. A device according to claim 34, wherein said prefiltration and postfiltration chambers are at least partially placed laterally to said filter element in correspondence of its thickness.

36. A device according to claim 35, wherein said prefiltration chamber and said postfiltration chamber are arranged on the same side with respect to said filter element.

37. A device according to claim 36, wherein said prefiltration chamber and said postfiltration chamber are arranged side by side.

38. A device according to claim 35, characterized in that said prefiltration chamber and said postfiltration chamber are arranged at opposite sides with respect to said filter element.

39. A device according to claim 34, wherein the opposite faces of said filter element cooperate with the top wall and the bottom wall of said containment body so as to force the water to pass through its thickness.

40. A device according to claim 39, wherein said top wall and said bottom wall are arranged at the opposite faces of said filter element so as to force the water to pass through the thickness of the filter element itself.

41. A device according to claim 34, wherein said containment body comprises at least a containment wall placed between said filter element and at least one between said prefiltration chamber and said postfiltration chamber, said containment wall being faced to the thickness of said filter element.

42. A device according to claim 41, wherein said containment wall extends between the top wall and the bottom wall of said containment body.

43. A device according to claim 41, wherein said prefiltration chamber and/or said postfiltration chamber is communicating with the thickness of said filter element by means of said at least a containment wall and it is substantially aligned to the thickness of the filter element itself.

44. A device according to claim 41, wherein said containment body comprises two of said containment walls, of which a first and a second containment wall placed between said filter element and, respectively, said prefiltration chamber and said postfiltration chamber.

45. A device according to claim 41, wherein said at least a containment wall comprises prefiltration means and/or postfiltration means adapted to allow the passage of water.

46. A device according to claim 45, wherein said first containment wall comprises said prefiltration means and said second containment wall comprises said postfiltration means.

47. A device according to claim 41, wherein said at least a containment wall defines at least a water passageway facing the thickness of the filter element itself.

48. A device according to claim 47, wherein said first and second containment walls define, respectively, a first and a second passageway of the water entering and exiting said filter element and that are facing the thickness of the filter element itself.

49. A device according to claim 48, wherein said passageways are arranged substantially transversal with respect to said inlet and to said outlet respectively.

50. A device according to claim 34, wherein it comprises at least a sealing element placed between said filter element and said containment body for separating at least said prefiltration chamber from said postfiltration chamber.

51. A device according to claim 50, wherein said sealing element is arranged around said filter element so as to surround its opposite faces and to force the water flow through the thickness of the filter element itself in a direction substantially parallel to its faces.

52. A device according to claim 34, wherein at least one between said inlet and said outlet is arranged along the ideal projection of said filter element.

53. A device according to claim 34, wherein it comprises at least two of said filter elements arranged in succession to each other between said inlet and said outlet.

54. A device according to claim 53, wherein said prefiltration chamber communicates with one of said filter elements and that said postfiltration chamber communicates with the other one of said filter elements.

55. A device according to claim 53, wherein it comprises at least a separation wall placed between said filter elements, said separation wall and said containment walls being arranged in such a way to define a labyrinthine path for the water.

56. A device according to claim 55, wherein said separation wall defines a further passageway of the water.

57. A device according to claim 56, wherein said further passageway is arranged distal from said pre and postfiltration means.

58. A device according to claim 56, wherein said separation wall extends from the region interposed between said prefiltration means and said postfiltration means.

59. A device according to claim 56, wherein said further passageway is arranged distal from said first and second passageways.

60. A device according to claim 53, wherein it comprises at least two of said sealing elements each one of them is associated to a relative filter element, said sealing element defining an intermediate chamber placed between them.

61. A device according to claim 34, wherein said containment body comprises at least one containment element that defines a closed edge placed inside said filtration chamber and that said filter element is placed watertight inside said containment element for separating said prefiltration chamber from said postfiltration chamber.

62. A device according to claim 61, wherein it comprises at least a sealing element arranged along the perimeter of the filter element in correspondence of its thickness and interposed between the filter element itself and the said containment element, said prefiltration and postfiltration chambers being delimited at least partially, respectively, by a first face and by a second face of said filter element.

63. A device according to claim 62, wherein said containment body comprises at least one support element that cooperates with said second face for compensating the force acting on the filter element itself and due to the pressure difference present, in use, at its ends.

64. A device according to claim 61, wherein said containment element presents at least two containment walls placed at opposite sides of said filter element and that cross partially said filtration chamber defining at least one inlet conduit communicating with said inlet and with said first face and at least one outlet conduit communicating with said outlet and with said second face.

65. A device according to claim 63, wherein it comprises a plurality of said support elements spaced from each other for defining passage conduits of the filtered water towards said outlet.

66. A device according to claim 34, wherein said filter element comprises at least a filtering material of the granular or foam type or of the kind of non woven tissue.
